(19) United States
(12) Patent Application Publication
(10) Pub. No.: US 2026/0148495 A1
(43) Pub. Date: May 28, 2026

(54) METHOD AND APPARATUS FOR RECONSTRUCTING THREE-DIMENSIONAL MODEL

(71) Applicant: BOE Technology Group Co., Ltd., Beijing (CN)

(72) Inventor: Kaiyu LI, Shenzhen, Guangdong (CN)

(21) Appl. No.: 19/122,757

(22) PCT Filed: Jan. 2, 2024
(86) PCT No.: PCT/CN2024/070029

§ 371 Date: Apr. 21, 2025

(30) Foreign Application Priority Data
Jan. 30, 2023 (CN) 202310104477.3

(51) Int. Cl. G06T 17/20

(52) U.S. Cl. CPC G06T 17/20; G06T 2207/10028

(57) ABSTRACT

The present disclosure relates to the technical field of three-dimensional model construction, and provides a method and apparatus for reconstructing a three-dimensional model, which may solve the problems of the structure being complex and modeling efficiency being low for existing three-dimensional models. The method for reconstructing a three-dimensional model of the present disclosure comprises: according to data features of a group of initial three-dimensional models, acquiring point cloud data of each initial model; selecting one model in the group of initial three-dimensional models as a standard three-dimensional model, and acquiring a plurality of discrete deformation fields by using difference values between points in the standard three-dimensional model and points in the other initial three-dimensional models; converting the plurality of discrete deformation fields into a statistical morphological model by using a multi-dimensional Gaussian process; and resampling the statistical morphological model, and acquiring a target three-dimensional model.

### CROSS-REFERENCE TO RELATED APPLICATIONS

The present application is a U.S. National Phase Entry of International Application No. PCT/CN2024/070029 having an international filing date of Jan. 2, 2024, which claims the priority to Chinese Patent Application No. 202310104477.3, filed on Jan. 30, 2023, the above-identified applications are incorporated into the present application by reference in their entireties.

### TECHNICAL FIELD

The present disclosure relates to the technical field of three-dimensional model construction, and particularly to a method and an apparatus for reconstructing a three-dimensional model.

### BACKGROUND

With the continuous development of three-dimensional model construction technology, three-dimensional models are widely used in more and more fields. Polygon optimization and smoothing of three-dimensional models is a very important part of the three-dimensional development process. Most three-dimensional models need to increase or decrease the number of polygons in the models according to application scenarios and usage conditions so as to achieve the purpose of optimization and smoothing, so that the models can be adapted to more scenarios.

However, at present, model editing is mainly done manually, and the workload required is comparable to that in rebuilding a three-dimensional model, which is huge. Moreover, there is no automatic operation for a deformer, which is a model animation solution used widely and having good effect in the three-dimensional field, in the model smoothing and optimization process. As a result, the workload is multiplied when dealing with deformer-related model optimization. Therefore, how to process a deformer through an automatic process to reconstruct a three-dimensional model is an urgent problem to be solved in the industry.

### SUMMARY

The present disclosure aims to at least solve one of the technical problems existing in the related art, and provides a method and an apparatus for reconstructing a three-dimensional model.

In a first aspect, an embodiment of the present disclosure provides a method for reconstructing a three-dimensional model, the method for reconstructing a three-dimensional model includes:
acquiring point cloud data of each initial three-dimensional model according to data features of a group of initial three-dimensional models;
selecting one model in the group of initial three-dimensional models as a standard three-dimensional model, and acquiring a plurality of discrete deformation fields by using difference values between points in the standard three-dimensional model and points in other initial three-dimensional models;
converting the plurality of discrete deformation fields into a statistical shape model by using a multi-dimensional Gaussian process; and
performing resampling for the statistical shape model to acquire a target three-dimensional model.

Optionally, acquiring the point cloud data of each initial three-dimensional model according to the data features of the group of initial three-dimensional models, includes:
setting a deformer of the initial three-dimensional model to an average state and acquiring an average state model;
acquiring limit state models of a plurality of deformation components of the deformer according to the average state model;
storing the average state model and the limit state models as readable data; and
sorting the readable data to acquire the point cloud data of the initial three-dimensional model.

Optionally, the limit state models include a positive limit model and a negative limit model.

Optionally, the readable data includes polygon file format data.

Optionally, selecting one model in the group of initial three-dimensional models as the standard three-dimensional model, and acquiring the plurality of discrete deformation fields by using the difference values between the points in the standard three-dimensional model and the points in the other initial three-dimensional models, includes:
acquiring a mesh corresponding to the point cloud data according to the point cloud data;
calculating a difference value between a point corresponding to the point cloud data and a reference point according to the mesh; and
acquiring the plurality of discrete deformation fields according to the difference value between the point corresponding to the point cloud data and the reference point.

Optionally, converting the plurality of discrete deformation fields into the statistical shape model by using the multi-dimensional Gaussian process includes:
acquiring an average value of various points and a covariance of each point according to the points corresponding to the point cloud data;
acquiring the multi-dimensional Gaussian process according to the average value and the covariance; and
acquiring the statistical shape model according to the multi-dimensional Gaussian process.

Optionally, performing resampling for the statistical shape model to acquire the target three-dimensional model includes:
selecting part of points according to the points in the statistical shape model; and
integrating the part of the points to acquire the target three-dimensional model.

In a second aspect, an embodiment of the present disclosure provides an apparatus for reconstructing a three-dimensional model, the apparatus for reconstructing a three-dimensional model includes:
a point cloud data acquisition module configured to acquire, according to data features of a group of initial three-dimensional models, point cloud data of each initial three-dimensional model;
a deformation field conversion module configured to select one model in the group of initial three-dimensional models as a standard three-dimensional model and acquire a plurality of discrete deformation fields by using difference values between points in the standard three-dimensional model and points in other initial three-dimensional models;
a statistical shape model conversion module configured to convert the plurality of discrete deformation fields into a statistical shape model by using a multi-dimensional Gaussian process; and
a target three-dimensional model acquisition module configured to perform resampling the statistical shape model to acquire a target three-dimensional model.

Optionally, the point cloud data acquisition module includes:
an average state model acquisition sub-module configured to set a deformer of the initial three-dimensional model to an average state and acquire an average state model;
a limit state model acquisition sub-module configured to acquire limit state models of a plurality of deformation components of the deformer according to the average state model;
a readable data storage sub-module configured to store the average state model and the limit state models as readable data; and
a sorting sub-module configured to sort the readable data to acquire the point cloud data of the initial three-dimensional model.

Optionally, the deformation field conversion module includes:
a mesh acquisition sub-module configured to acquire a mesh corresponding to the point cloud data according to the point cloud data;
a difference value calculation sub-module configured to calculate a difference value between a point corresponding to the point cloud data and a reference point according to the mesh; and
an interpolation sub-module configured to acquire the plurality of discrete deformation fields according to the difference value between the point corresponding to the point cloud data and the reference point.

Optionally, the statistical shape model conversion module includes:
an average value and covariance acquisition sub-module configured to acquire an average value of various points and a covariance of each point according to the points corresponding to the point cloud data;
a multi-dimensional Gaussian process acquisition sub-module configured to acquire the multi-dimensional Gaussian process according to the average value and the covariance; and
a statistical shape model acquisition sub-module configured to acquire the statistical shape model according to the multi-dimensional Gaussian process.

Optionally, the target three-dimensional model acquisition module includes:
a selection sub-module configured to select, according to points in the statistical shape model, part of the points; and
an integration sub-module configured to integrate the part of the points to acquire the target three-dimensional model.

In a third aspect, an embodiment of the present disclosure provides an electronic device, including: at least one processor; and a memory in communication with the at least one processor. One or more computer programs executable by the at least one processor are stored in the memory, the one or more computer programs are executed by the at least one processor to enable the at least one processor to implement the method for reconstructing a three-dimensional model as provided above.

In a fourth aspect, an embodiment of the present disclosure provides a computer-readable storage medium having a computer program stored thereon, and when the computer program is executed by a processor, the method for reconstructing a three-dimensional model as provided above is implemented.

### BRIEF DESCRIPTION OF DRAWINGS

FIG. 1 is a schematic diagram of flow of a method for constructing a three-dimensional model according to an embodiment of the present disclosure.

FIG. 2 is a schematic diagram of flow of a method for acquiring point cloud data of an initial model.

FIG. 3 is a schematic diagram of flow of a method for deformation field conversion.

FIG. 4 is a schematic diagram of a structure of an exemplary three-dimensional model.

FIG. 5 is a schematic diagram of flow of a method for statistical shape model conversion.

FIG. 6 is a schematic diagram of a structure of another exemplary three-dimensional model.

FIG. 7 is a schematic diagram of flow of a method for acquiring a target three-dimensional model.

FIG. 8 is a schematic diagram of a structure of an apparatus for reconstructing a three-dimensional model according to an embodiment of the present disclosure.

FIG. 9 is a schematic diagram of a structure of an electronic device according to some embodiments of the present disclosure.

### DETAILED DESCRIPTION

To make those skilled in the art better understand technical solutions of the present disclosure, the present disclosure is described in further detail below with reference to the accompanying drawings and the specific implementations.

Unless otherwise defined, technical terms or scientific terms used in the present disclosure should have the meanings as commonly understood by those of ordinary skills in the art that the present disclosure belongs to. The term “first”, “second” and similar terms used in the present disclosure do not indicate any order, quantity, or importance, but are used only for distinguishing different components. Similarly, similar words such as “a”, “an” or “the” do not denote a limitation on quantity, but rather denote the presence of at least one. “Include”, “contain”, or similar words mean that elements or objects appearing before the words cover elements or objects listed after the words and their equivalents, but do not exclude other elements or objects. “Connect”, “couple”, or similar words are not limited to a physical or mechanical connection, but may include an electrical connection, whether direct or indirect. “Upper”, “lower”, “left”, and “right”, etc., are used for representing a relative positional relationship, and when an absolute position of a described object is changed, the relative positional relationship may also be correspondingly changed.

In the three-dimensional model construction technology, the number of polygons in the model needs to be increased or decreased according to the application scenarios and usage conditions to achieve the purpose of optimization and smoothing, so that the model can be adapted to more scenarios. However, at present, model editing is mainly done manually, and the workload required is comparable to that in rebuilding a three-dimensional model, which is huge. Moreover, there is no automatic operation for a deformer, which is a model animation solution used widely and having good effect in the three-dimensional field, in the model smoothing and optimization process. As a result, workload is multiplied when dealing with deformer-related model optimization.

In order to at least solve one of the above-described technical problems, embodiments of the present disclosure provide a method and an apparatus for reconstructing a three-dimensional model. The method and apparatus for reconstructing a three-dimensional model provided by the embodiments of the present disclosure will be further described in details below with reference to the drawings and specific implementations.

It is noted herein that in order to better describe the method and apparatus for constructing a three-dimensional model provided in the embodiments of the present disclosure, the terms involved therein are explained here.

A Statistical Shape Model (SSM) is a geometric model that describes a set of semantically similar objects in a very compact way. SSM represents an average shape of a series of three-dimensional objects and their variations in shape. The creation of SSM requires corresponding mapping, and this can be achieved by respective sampling parameterization. Variations in individual shape features can be studied mathematically if corresponding parameterization can be established for all shapes.

A deformer (Blend shape) is a technique of deforming a single mesh to achieve numerous pre-defined shapes and combinations of any number of these shapes. In Maya/3ds Max, we call it a deformation target, e.g., a single mesh is of a basic shape (an expressionless face for example) which is a default shape, and other shapes for the basic shape are used for blending/deforming and are different expressions (laughing, frowning, closing eyelids), and these are collectively referred to as blend-shapes or deformation targets. In practice, it is manifested as manipulating a set of models with different shapes but identical topological information such as the number of model points and wiring to practically deform the models into a certain shape of that set of models by using a series of parameters.

Polygon smoothing optimization is to optimize a model in terms of the number of faces and the face structure by modifying polygons of the model. If the faces of the model need to be changed by increasing the number of faces of the model, it is polygon smoothing of the model. If the faces of the model need to be changed by reducing the number of faces of the model, it is polygon optimization of the model.

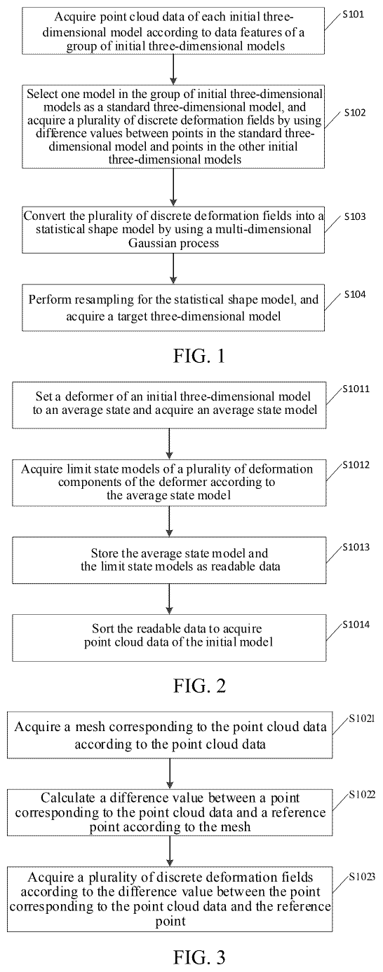

In the first aspect, an embodiment of the present disclosure provides a method for constructing a three-dimensional model. FIG. 1 is a schematic diagram of flow of a method for constructing a three-dimensional model according to an embodiment of the present disclosure. As shown in FIG. 1, the method for constructing a three-dimensional model includes the following acts S101 to S104.

In S101, point cloud data of each initial three-dimensional model is acquired according to data features of a group of initial three-dimensional models.

In act S101, an initial three-dimensional model is specifically a three-dimensional model of a human body, e.g., an entire human body or a part of the human body, which may be a hand, a foot, a head, an internal organ, or the like. For example, an initial three-dimensional model is a three-dimensional model of a hand, its data features may include: a length and a width of each finger, a range of movement of each finger in a three-dimensional space, etc. The initial three-dimensional model can be stored in a format such as RVT, 3DS, DWG, FBX, IFC, OSGB, and OBJ, which can be read and processed by software such as 3DMAX, SoftImage, Maya, UG, and AutoCAD. Multiple point cloud data can form a mesh. The mesh is usually composed of triangles, quadrilaterals or other simple convex polygons, and the final mesh can form a three-dimensional model. Power data can be stored in a binary file format such as las, laz, pcd, pcap, ply, and pts.

S102, one model in the group of initial three-dimensional models is selected as a standard three-dimensional model, and a plurality of discrete deformation fields are acquired by using difference values between points in the standard three-dimensional model and points in the other initial three-dimensional models.

In act S102, the converted point cloud data has a feature that all meshes are in one-to-one correspondence, e.g., the tenth point cloud data in each initial three-dimensional model represents a middle finger of a hand. One of the initial three-dimensional models is selected as a standard three-dimensional model, and the standard three-dimensional model has a moderate morphology, e.g., a three-dimensional model in which the fingers are in a normal stretched state. Each point cloud data can only represent a certain point in the hand, and the points are discontinuous. Difference values between the points in the standard three-dimensional model and the points in the other initial three-dimensional models can be calculated to form multiple discontinuous deformation fields, i.e., discrete deformation fields.

S103, the plurality of discrete deformation fields are converted into a statistical shape model by using a multi-dimensional Gaussian process.

In act S103, data of the plurality of discrete deformation fields is introduced into a Gaussian process formula, to perform interpolating between the plurality of discrete deformation fields, so that the plurality of discrete deformation fields constitute a deformation field in a continuous domain, and the plurality of deformation fields in a continuous domain can constitute a statistical shape model.

S104, resampling is performed for the statistical shape model to acquire a target three-dimensional model.

In act S104, for the statistical shape model having a continuous domain, nearest neighbor interpolation, bilinear interpolation, cubic convolution interpolation, etc. may be employed to select some of the points therein to form a new three-dimensional model, i.e., a target three-dimensional model.

In the method for reconstructing a three-dimensional model provided in an embodiment of the present disclosure, first, point cloud data of an initial three-dimensional model can be acquired, each point cloud data corresponds to a point in a mesh, the point cloud data can be converted into a deformation field in the mesh, and the space between mesh points can be processed by interpolation calculation to form a plurality of discrete deformation fields, then the plurality of discrete deformation fields can be converted into a statistical shape model having deformation fields in a continuous domain by using a multi-dimensional Gaussian process, and resampling is performed for the statistical shape model according to the application scenario to obtain a deformer with a specific number of mesh points, so as to achieve smoothing optimization of the deformer model and form a target three-dimensional model. In this way, in some non-functional characteristics of the three-dimensional model can be improved without changing the functional characteristics of the original model, e.g., improving the readability of the three-dimensional model, reducing the complexity of the original model, etc., and the three-dimensional model can be reconstructed by automatic means, thus greatly reducing the workload, effectively improving the efficiency of three-dimensional model reconstruction.

In some embodiments, FIG. 2 is a schematic diagram of flow of a method for acquiring point cloud data of an initial model, and as shown in FIG. 2, the above act S101, i.e., acquiring point cloud data of each initial three-dimensional model according to data features of a group of initial three-dimensional models, includes the following acts S1011 to S1014.

In S1011, a deformer of the initial three-dimensional model is set to an average state and an average state model is acquired.

In S1012, limit state models of a plurality of deformation components of the deformer are acquired according to the average state model.

In S1013, the average state model and the limit state models are stored as readable data.

In S1014, the readable data is sorted to acquire the point cloud data of the initial three-dimensional model.

Specifically, in this act, it is mainly needed to convert one three-dimensional model containing a deformer into various discrete models for software processing in a next act. First, the deformer may be set to an average state, and then the largest value of various deformation components of the deformer may be separately selected to derive this model. In a specific example, the deformer has five deformation components, then ten separate models need to be derived, i.e., positive and negative limit state models for each deformation component in the average state, and the initial average state model also needs to be derived as a reference at the same time. It should be noted herein that, taking the horizontal direction as a deformation component, a limit position to which a mesh point in a three-dimensional model moves leftwards in the horizontal direction may be defined as its negative limit state, and a limit position to which a mesh point in the three-dimensional model moves rightwards in the horizontal direction may be defined as its positive limit state. For the deformation components in other directions, reference may be made to the above description, which will not be listed in details herein.

In order to facilitate reading of the three-dimensional model, mesh information of the three-dimensional model is mainly derived by using a model in a polygon file format (ply). After the model is derived, model data also needs to be processed. The main purpose is to convert the complete model information into a point cloud state, i.e., merely sequentially saving point coordinate data in the model file, to obtain point cloud data of the initial model.

In some embodiments, FIG. 3 is a schematic diagram of flow of a method for deformation field conversion, and as shown in FIG. 3, the above act S102, i.e., selecting one model in the group of initial three-dimensional models as the standard three-dimensional model and acquiring the plurality of discrete deformation fields by using the difference values between the points in the standard three-dimensional model and the points in the other initial three-dimensional models, includes the following acts S1021 to S1023.

In S1021, a mesh corresponding to the point cloud data is acquired according to the point cloud data.

In S1022, a difference value between a point corresponding to the point cloud data and a reference point is calculated according to the mesh.

In S1023, a plurality of discrete deformation fields are acquired according to the difference value between the point corresponding to the point cloud data and the reference point.

Specifically, the point cloud data converted through the previous stage has a feature, i.e., the meshes are all in correspondence. That is, they all have the same number of points, and points with the same address in the meshes represent same points/regions in the meshes.

Any mesh corresponding to this reference may be represented as a deformation field, and the deformation field is defined on this reference mesh; i.e., points of the reference mesh are domains for defining the deformation field. Deformation may be calculated by a difference value between a corresponding point of the mesh and a reference point.

The deformation fields acquired in the above acts are discrete because they are defined only on the mesh points. This is not ideal because the modeled real-world objects are continuous and discretization of the meshes is rather arbitrary. In a solution of an embodiment of the present disclosure, continuous representation of the deformation fields needs to be obtained by interpolation. Interpolation may be found by searching for a closest point on a surface for each point in a three-dimensional space, and a corresponding deformation may be used as a deformation for a given point. The points on a curved surface are obtained by barycentric interpolation of corresponding vertices. As a consequence of interpolation, the deformation field of the whole real space is obtained, i.e., the deformation field corresponding to any point may be acquired.

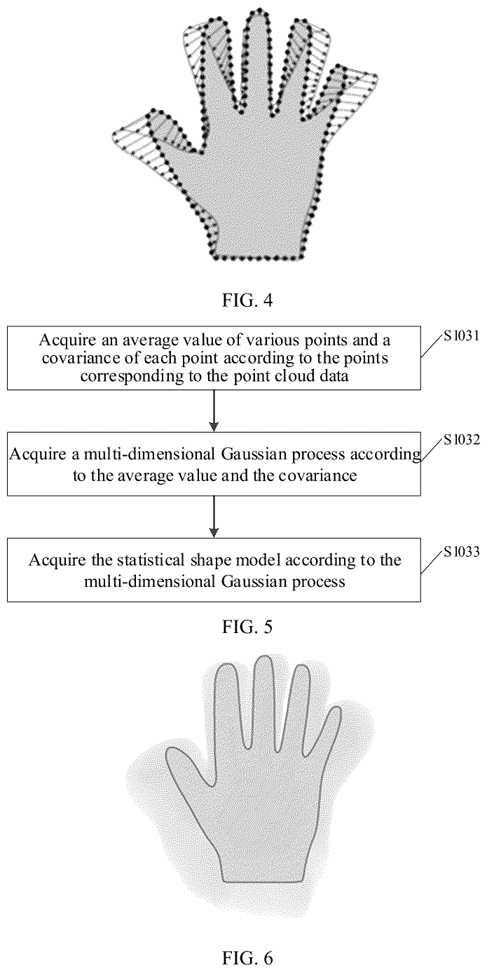

FIG. 4 is a schematic diagram of a structure of an exemplary three-dimensional model. As shown in FIG. 4, a graphic is converted into interpolations from a reference model to corresponding point positions of the graphic, i.e., a deformation field. In FIG. 4, it is a model shape of a hand composed of contour points, and an averaged state is shown in the black points. The black point contour may be regarded as a basis. In the other hand-shaped contour, i.e., the contour pointed by the arrows in the figure, the direction indicated by the arrow is expressed in a form of a vector of a corresponding point from a black point, i.e., a reference point of the point, to an actual point position of the point in the other hand-shaped contour. This operation may be performed for each point of each model, and this is a deformation field.

With continuous reference to FIG. 4, the existing contour of this hand-shaped three-dimensional model is composed of a set of points, so the actually expressed model is a discrete contour. When we connect these points with a line, a continuous contour, rather than a series of spaced-apart points, is obtained, thus realizing continuity of the contour, i.e., it may be represented by a set of y(x) functions, and similarly, a deformation field in a continuous domain can be generated by performing the above-mentioned deformation field extraction operation on two continuous hand contours, i.e., making subtraction between corresponding coordinates of the two hand-shaped contours in FIG. 4.

In some embodiments, FIG. 5 is a schematic diagram of flow of a method for statistical shape model conversion, and as shown in FIG. 5, the above act S103, i.e., converting the plurality of discrete deformation fields into the statistical shape model by using the multi-dimensional Gaussian process, includes the following acts S1031 to S1033.

In S1031, an average value of various points and a covariance of each point are acquired according to the point corresponding to the point cloud data.

In S1032, the multi-dimensional Gaussian process is acquired according to the average value and the covariance.

In S1033, the statistical shape model is acquired according to the multi-dimensional Gaussian process.

Specifically, taking a deformer having five deformation components as an example, a total of eleven models are acquired, and a positive maximum model and a negative maximum model corresponding to each deformation component are taken as a group to calculate a statistical shape model of a continuous domain. In this act, the following logic will be used, that is, for each group, an average value u of all points in the model is calculated (Equation 2), and then a covariance of any corresponding point is calculated (Equation 1).

$$k ( x , {x}^{′} ) = \frac{1}{n - 1} {\sum }_{i}^{n} ( {u}^{i} ( x ) - \overline{u} \text{?} ( x ) ) {( {u}^{i} ( x \text{?} ) - \overline{u} ( x \text{?} ) )}^{T} \qquad ( Equation 1 )$$

$$μ ( x ) = \overline{u} ( x ) = \frac{1}{n} {\sum }_{i = 1}^{n} {u}^{i} ( x ) \qquad ( Equation 2 )$$

$$\text{?} \text{indicates text missing or illegible when filed}$$

Finally, μ and Σ are introduced into a multi-dimensional Gaussian process (Equation 3).

$$p ( x ; μ , Σ ) = \frac{1}{( 2 π ) \text{?} \vert Σ \vert \text{?}} exp ( - \frac{1}{2} {( x - μ )}^{T} {Σ}^{- 1} ( x - μ ) ) \qquad ( Equation 3 )$$

$$\text{?} \text{indicates text missing or illegible when filed}$$

In this way, a multi-dimensional Gaussian process is obtained, this process includes a lot of information and properties that can be extracted, but in the embodiments of the present disclosure, this Gaussian process is mainly used as a sum of the model deformation fields. In summary, in the above mathematical calculations, continuity is performed on multiple models and then the multiple models are reintegrated together, and still taking a hand-shaped model as an example, as shown in FIG. 6, the black contour is a hand shape that we set as an average model, in case of different black shadows around the hand shape, the positions that the hand contour may reach in different models can be understood as shadows resulting from superimposition of a series of spread hands in different shapes. In this process, the following information is learnt in this Gaussian process, i.e., when some points of the hand contour appear at certain positions in the shadow, the position of each point of the whole contour can be obtained.

Through the above explanation, when the positions of a limited number of points in the positive maximum model corresponding to a certain deformation component are input in the above Gaussian process, an expression of the whole contour is obtained, and a continuous expression of the whole contour is obtained.

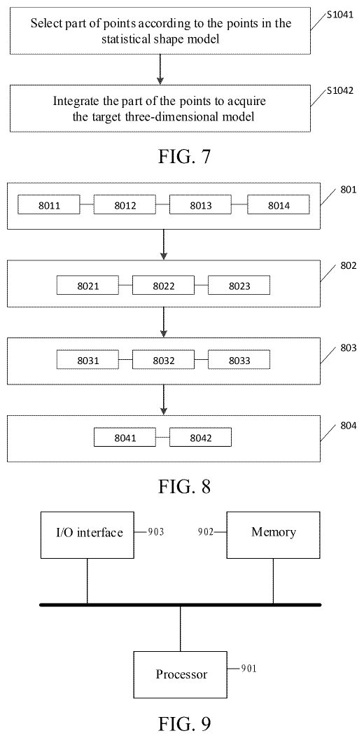

In some embodiments, FIG. 7 is a schematic diagram of flow of a method for acquiring a target three-dimensional model, and as shown in FIG. 7, the above act S104, i.e., performing resampling for the statistical shape model to acquire the target three-dimensional model, includes the following acts S1041 to S1042.

In S1041, part of points is selected according to the points in the statistical shape model.

In S1042, the part of the points is integrated to acquire the target three-dimensional model.

Specifically, after the operations of the above acts, expression of the positive maximum model corresponding to a certain deformation component in a continuous space can be obtained, and after realization of this act, new point positions of the model can be acquired just by performing resampling for the model according to actual needs. Still taking a hand-shaped model as an example, after a contour line of a shape of the hand is obtained, when a hand contour point map consisting of 100 points is needed, only the needed 100 points need to be selected in the whole contour line according to needs to realize smoothing or optimization of the whole three-dimensional model.

For the finally generated new deformer, the operations for the combination of a group of models in different shapes are the same as the operations above, it is only required to perform resampling in the standard model in the whole Gaussian process, and according to the characteristics that the positions of the points of the whole model are all in correspondence, new models in different shapes in which points are also selected in this region can be obtained to form a new deformer. In the original deformer, the points are dense, and there are many points in the model. By performing smoothing optimization of resampling after corresponding operations, a deformer model with fewer points is generated.

In the second aspect, an embodiment of the present disclosure provides an apparatus for reconstructing a three-dimensional model. FIG. 8 is a schematic diagram of a structure of an apparatus for reconstructing a three-dimensional model according to an embodiment of the present disclosure. As shown in FIG. 8, the apparatus for reconstructing a three-dimensional model includes: a point cloud data acquisition module 801, a deformation field conversion module 802, a statistical shape model conversion module 803, and a target three-dimensional model acquisition module 804.

The point cloud data acquisition module 801 is configured to acquire, according to data features of a group of initial three-dimensional models, point cloud data of each initial three-dimensional model. The deformation field conversion module 802 is configured to select one model in the group of initial three-dimensional models as a standard three-dimensional model and acquire a plurality of discrete deformation fields by using difference values between points in the standard three-dimensional model and points in the other initial three-dimensional models. The statistical shape model conversion module 803 is configured to convert the plurality of discrete deformation fields into a statistical shape model by using a multi-dimensional Gaussian process. The target three-dimensional model acquisition module 804 is configured to perform resampling for the statistical shape model to acquire a target three-dimensional model.

The apparatus for reconstructing a three-dimensional model according to an embodiment of the present disclosure is used for implementing the method for reconstructing a three-dimensional model according to any one of the above-described embodiments. As to the specific description thereof, reference may be made to the description on the method for reconstructing a three-dimensional model according to any one of the above-described embodiments, and no further description is made here.

Specifically, the point cloud data acquisition module 801 includes: an average state model acquisition sub-module 8011 configured to set a deformer of the initial three-dimensional model to an average state and acquire an average state model; a limit state model acquisition sub-module 8012 configured to acquire limit state models of a plurality of deformation components of the deformer according to the average state model; a readable data storage sub-module 8013 configured to store the average state model and the limit state models as readable data; and a sorting sub-module 8014 configured to sort the readable data to acquire the point cloud data of the three-dimensional initial model.

The deformation field conversion module 802 includes: a mesh acquisition sub-module 8021 configured to acquire a mesh corresponding to the point cloud data according to the point cloud data; a difference value calculation sub-module 8022 configured to calculate a difference value between a point corresponding to the point cloud data and a reference point according to the mesh; and an interpolation sub-module 8023 configured to acquire a deformation field of a continuous domain according to the difference value between the point corresponding to the point cloud data and the reference point.

The statistical shape model conversion module 803 includes: an average value and covariance acquisition sub-module 8031 configured to acquire an average value of various points and a covariance of each point according to the point corresponding to the point cloud data; a multi-dimensional Gaussian process acquisition sub-module 8032 configured to acquire the multi-dimensional Gaussian process according to the average value and the covariance; and a statistical shape model acquisition sub-module 8033 configured to acquire a statistical shape model according to the multi-dimensional Gaussian process.

The target three-dimensional model acquisition module 804 includes: a selection sub-module 8041 configured to select, according to points in the statistical shape model, part of the points; and an integration sub-module 8042 configured to integrate the part of the points to acquire a target three-dimensional model.

In the third aspect, an embodiment of the present disclosure provides an electronic device. FIG. 9 is a schematic diagram of a structure of an electronic device according to some embodiments of the present disclosure. As shown in FIG. 9, the electronic device includes: one or more processors 901; a memory 902 having one or more programs stored thereon, when the one or more programs are executed by the one or more processors, the one or more processors being caused to implement the method for reconstructing a three-dimensional model provided in any one of the above-described embodiments; and one or more I/O interfaces 903 connected between the processor(s) and the memory and configured to implement information interaction between the processor(s) and the memory.

Herein, the processor 901 is a device with data processing capability, including but not limited to a central processing unit (CPU), etc., The memory 902 is a device with data storage capability, including but not limited to a random access memory (RAM, more specifically SDRAM, DDR, etc.), a read only memory (ROM), an electrically erasable programmable read only memory (EEPROM), flash memory (FLASH). The I/O interface (read-write interface) 903 is connected between the processor 901 and the memory 902, and can achieve information interaction between the processor 901 and the memory 902, including but not limited to a data bus (Bus) and the like.

In some embodiments, the processor 901, the memory 902, and the I/O interface 903 are connected to each other via a bus, so as to be connected with other components of the computing device.

In the fourth aspect, an embodiment of the present disclosure provides a computer-readable medium having a computer program stored thereon, when the program is executed by a processor, the method for reconstructing a three-dimensional model according to any one of the above-described embodiments is implemented.

Those of ordinary skills in the art may understand that all or some of acts in the methods disclosed above, systems, functional modules or units in apparatuses may be implemented as software, firmware, hardware, and an appropriate combination thereof. In a hardware implementation mode, division of the function modules/units mentioned in the above description is not always corresponding to division of physical components. For example, a physical component may have multiple functions, or a function or an act may be executed by several physical components in cooperation. Some physical components or all physical components may be implemented as software executed by a processor such as a central processor, a digital signal processor or a microprocessor, or implemented as hardware, or implemented as an integrated circuit such as a specific integrated circuit. Such software may be distributed on a computer readable medium, and the computer readable medium may include a computer storage medium (or a non-transitory medium) and a communication medium (or a transitory medium). As known to those of ordinary skills in the art, a term computer storage medium includes volatile and nonvolatile, removable and irremovable media implemented in any method or technology for storing information (for example, computer-readable instructions, a data structure, a program module, or other data). The computer storage medium includes, but is not limited to, a RAM, a ROM, an EEPROM, a flash memory or another memory technology, a CD-ROM, a Digital Versatile Disk (DVD) or another optical disk storage, a magnetic cartridge, a magnetic tape, magnetic disk storage or another magnetic storage apparatus, or any other medium that may be used for storing desired information and may be accessed by a computer. In addition, it is known to those of ordinary skills in the art that the communication medium usually includes computer-readable instructions, a data structure, a program module, or other data in a modulated data signal, such as, a carrier or other transmission mechanisms, and may include any information delivery medium.

It may be understood that the above implementations are only exemplary implementations employed for the purpose of illustrating the principles of the present disclosure. However the present disclosure is not limited thereto. To those of ordinary skills in the art, various modifications and improvements may be made without departing from the essence and substance of the present disclosure, and these modifications and improvements are also considered to be within the scope of the present disclosure.

1. A method for reconstructing a three-dimensional model, comprising:
acquiring point cloud data of each initial three-dimensional model according to data features of a group of initial three-dimensional models;
selecting one model in the group of initial three-dimensional models as a standard three-dimensional model, and acquiring a plurality of discrete deformation fields by using difference values between points in the standard three-dimensional model and points in other initial three-dimensional models;
converting the plurality of discrete deformation fields into a statistical shape model by using a multi-dimensional Gaussian process; and
performing resampling for the statistical shape model to acquire a target three-dimensional model.

2. The method for reconstructing a three-dimensional model according to claim 1, wherein acquiring the point cloud data of each initial three-dimensional model according to the data features of the group of initial three-dimensional models comprises:
setting a deformer of the initial three-dimensional model to an average state and acquiring an average state model;
acquiring limit state models of a plurality of deformation components of the deformer according to the average state model;
storing the average state model and the limit state models as readable data; and
sorting the readable data to acquire the point cloud data of the initial three-dimensional model.

3. The method for reconstructing a three-dimensional model according to claim 2, wherein the limit state models comprise a positive limit model and a negative limit model.

4. The method for reconstructing a three-dimensional model according to claim 2, wherein the readable data comprises polygon file format data.

5. The method for reconstructing a three-dimensional model according to claim 2, wherein selecting one model in the group of initial three-dimensional models as the standard three-dimensional model, and acquiring the plurality of discrete deformation fields by using the difference values between the points in the standard three-dimensional model and the points in the other initial three-dimensional models, comprises:
acquiring a mesh corresponding to the point cloud data according to the point cloud data;
calculating a difference value between a point corresponding to the point cloud data and a reference point according to the mesh; and
acquiring the plurality of discrete deformation fields according to the difference value between the point corresponding to the point cloud data and the reference point.

6. The method for reconstructing a three-dimensional model according to claim 5, wherein converting the plurality of discrete deformation fields into the statistical shape model by using the multi-dimensional Gaussian process comprises:
acquiring an average value of various points and a covariance of each point according to the points corresponding to the point cloud data;
acquiring the multi-dimensional Gaussian process according to the average value and the covariance; and
acquiring the statistical shape model according to the multi-dimensional Gaussian process.

7. The method for reconstructing a three-dimensional model according to claim 6, wherein performing resampling for the statistical shape model to acquire the target three-dimensional model comprises:
selecting part of points according to the points in the statistical shape model; and
integrating the part of the points to acquire the target three-dimensional model.

8. An apparatus for reconstructing a three-dimensional model, comprising:
a point cloud data acquisition module configured to acquire, according to data features of a group of initial three-dimensional models, point cloud data of each initial three-dimensional model;
a deformation field conversion module configured to select one model in the group of initial three-dimensional models as a standard three-dimensional model and acquire a plurality of discrete deformation fields by using difference values between points in the standard three-dimensional model and points in other initial three-dimensional models;
a statistical shape model conversion module configured to convert the plurality of discrete deformation fields into a statistical shape model by using a multi-dimensional Gaussian process; and
a target three-dimensional model acquisition module configured to perform resampling the statistical shape model to acquire a target three-dimensional model.

9. The apparatus for reconstructing a three-dimensional model according to claim 8, wherein the point cloud data acquisition module comprises:
an average state model acquisition sub-module configured to set a deformer of the initial three-dimensional model to an average state and acquire an average state model;
a limit state model acquisition sub-module configured to acquire limit state models of a plurality of deformation components of the deformer according to the average state model;
a readable data storage sub-module configured to store the average state model and the limit state models as readable data; and
a sorting sub-module configured to sort the readable data to acquire the point cloud data of the initial three-dimensional model.

10. The apparatus for reconstructing a three-dimensional model according to claim 9, wherein the deformation field conversion module comprises:
a mesh acquisition sub-module configured to acquire a mesh corresponding to the point cloud data according to the point cloud data;
a difference value calculation sub-module configured to calculate a difference value between a point corresponding to the point cloud data and a reference point according to the mesh; and
an interpolation sub-module configured to acquire the plurality of discrete deformation fields according to the difference value between the point corresponding to the point cloud data and the reference point.

11. The apparatus for reconstructing a three-dimensional model according to claim 10, wherein the statistical shape model conversion module comprises:
an average value and covariance acquisition sub-module configured to acquire an average value of various points and a covariance of each point according to the points corresponding to the point cloud data;
a multi-dimensional Gaussian process acquisition sub-module configured to acquire the multi-dimensional Gaussian process according to the average value and the covariance; and
a statistical shape model acquisition sub-module configured to acquire the statistical shape model according to the multi-dimensional Gaussian process.

12. The apparatus for reconstructing a three-dimensional model according to claim 11, wherein the target three-dimensional model acquisition module comprises:
a selection sub-module configured to select, according to points in the statistical shape model, part of the points; and
an integration sub-module configured to integrate the part of the points to acquire the target three-dimensional model.

13. An electronic device, comprising:
at least one processor; and
a memory in communication with the at least one processor; wherein
one or more computer programs executable by the at least one processor are stored in the memory, the one or more computer programs are executed by the at least one processor to enable the at least one processor to implement the method for reconstructing a three-dimensional model according to claim 1.

14. A non-transient computer-readable storage medium having a computer program stored thereon, wherein when the computer program is executed by a processor, the method for reconstructing a three-dimensional model according to claim 1 is implemented.
